(19) United States
(12) Patent Application Publication
(10) Pub. No.: US 2025/0294275 A1
(43) Pub. Date: Sep. 18, 2025

(54) APPARATUS AND METHOD FOR ACQUIRING DATA SYNCHRONIZATION IN PASSIVE OPTICAL NETWORK

(71) Applicant: ELECTRONICS AND TELECOMMUNICATIONS RESEARCH INSTITUTE, Daejeon (KR)

(72) Inventors: Kyeong-Hwan DOO, Daejeon (KR); Kwang-Ok KIM, Daejeon (KR); Hwan-Seok CHUNG, Daejeon (KR)

(73) Assignee: ELECTRONICS AND TELECOMMUNICATIONS RESEARCH INSTITUTE, Daejeon (KR)

(21) Appl. No.: 19/081,308

(22) Filed: Mar. 17, 2025

(30) Foreign Application Priority Data
Mar. 18, 2024 (KR) 10-2024-0037120

(51) Int. Cl. H04Q 11/00; H04J 14/02

(52) U.S. Cl. CPC H04Q 11/0067; H04J 14/023; H04Q 2011/0064; H04Q 2011/0079

(57) ABSTRACT

Disclosed herein are an apparatus and method for acquiring data synchronization in a passive optical network. The apparatus for acquiring data synchronization in a passive optical network is configured to receive at least two streams of serial data using at least two deserializers, perform lane delay control on the at least two streams of serial data based on a preset lane number and a preset number of bit delays, and acquire data synchronization from parallel data obtained by combining the at least two streams of serial data through the lane delay control.

### CROSS REFERENCE TO RELATED APPLICATION

This application claims the benefit of Korean Patent Application No. 10-2024-0037120, filed Mar. 18, 2024, which is hereby incorporated by reference in its entirety into this application.

### BACKGROUND OF THE INVENTION

### 1. Technical Field

The present disclosure relates generally to passive optical network technology, and more particularly to technology for implementing a high-speed interface and acquiring data synchronization in a passive optical network using a Time Division Multiplexing (TDM) method.

### 2. Description of the Related Art

Passive optical network technology having high economic efficiency is widely used in wired Fiber To The Home (FTTH) networks. The international standardization of Passive Optical Network (PON) is carried out by two organizations, that is, the International Telecommunication Union Telecommunication Standardization Sector (ITU-T) and Institute of Electrical and Electronics Engineers (IEEE), and the transmission speed of PON has advanced over time in line with the progress of standardization. Currently, ITU-T is in the final stage of completing the 50G-PON standard. 50G-PON has a transmission speed of 4976.64 Mb/s (hereinafter also referred to as 50 Gb/s) per wavelength. Since the maximum speed of Non-Return-to-Zero (NRZ) Serializer/Deserializer (SerDes) of current available Field Programmable Gate Array (FPGA) is about 32 Gb/s, 50G-PON cannot be implemented using only a single SerDes, and 50G SerDes IP for system semiconductor (e.g., Application-Specific Integrated Circuit: ASIC) is very expensive.

Meanwhile, U.S. Pat. No. 11,516,563 entitled “Passive optical network (PON) synchronization and clock recovery” discloses a method for receiving a PON frame from an Optical Network Unit (ONU) and matching bits included in the PON frame with a prestored sequence, thus performing synchronization of the PON frame.

### SUMMARY OF THE INVENTION

Accordingly, the present disclosure has been made keeping in mind the above problems occurring in the prior art, and an object of the present disclosure is to provide a high-speed interface structure and high-speed synchronization acquisition of PON media access controller (MAC)/physical interface transceiver (PHY).

Another object of the present disclosure is to increase price competitiveness without using an expensive Serializer/Deserializer (SerDes).

In accordance with an aspect of the present disclosure to accomplish the above objects, there is provided an apparatus for acquiring data synchronization in a passive optical network, including one or more processors, and memory configured to store at least one program that is executed by the one or more processors, wherein the at least one program is configured to receive at least two streams of serial data using at least two deserializers, perform lane delay control on the at least two streams of serial data based on a preset lane number and a preset number of bit delays, and acquire data synchronization from parallel data obtained by combining the at least two streams of serial data through the lane delay control.

The at least one program may be configured to delay the at least two streams of serial data that are input to the at least two deserializers by a preset number of bit delays for each preset lane number.

The at least one program may be configured to perform synchronization acquisition in the parallel data while increasing the preset number of bit delays for any one of the at least two deserializers by one bit.

The at least one program may be configured to perform synchronization acquisition in the parallel data while increasing the preset number of bit delays for a remaining one of the at least two deserializers by one bit.

The at least one program may be configured to, when the preset number of bit delays for the remaining one of the at least two deserializers reaches a maximum delay value, reset an output time of the parallel data to an initial state and change a current lane to a next lane.

The at least one program may be configured to compensate for skew between lanes using a delay time when data synchronization is acquired in the parallel data while changing the number of bit delays for each lane.

In accordance with an aspect of the present disclosure to accomplish the above objects, there is provided a method for acquiring data synchronization in a passive optical network, the method being performed by an apparatus for acquiring data synchronization in the passive optical network, the method including receiving at least two streams of serial data using at least two deserializers, performing lane delay control on the at least two streams of serial data based on a preset lane number and a preset number of bit delays, and acquiring data synchronization from parallel data obtained by combining the at least two streams of serial data through the lane delay control.

Performing the lane delay control may include delaying the at least two streams of serial data that are input to the at least two deserializers by a preset number of bit delays for each preset lane number.

Acquiring the data synchronization may include performing synchronization acquisition in the parallel data while increasing the preset number of bit delays for any one of the at least two deserializers by one bit.

Acquiring the data synchronization may further include performing synchronization acquisition in the parallel data while increasing the preset number of bit delays for a remaining one of the at least two deserializers by one bit.

Acquiring the data synchronization may further include, when the preset number of bit delays for the remaining one of the at least two deserializers reaches a maximum delay value, resetting an output time of the parallel data to an initial state and changing a current lane to a next lane.

Acquiring the data synchronization may further include compensating for skew between lanes using a delay time when data synchronization is acquired in the parallel data while changing the number of bit delays for each lane.

### BRIEF DESCRIPTION OF THE DRAWINGS

The above and other objects, features and advantages of the present disclosure will be better understood from the following detailed description in conjunction with the accompanying drawings, in which:

FIG. 1 is a block diagram illustrating a passive optical network according to an embodiment of the present disclosure;

FIG. 2 is a block diagram illustrating a data interface between a PON MAC/PHY chip and an optical transceiver according to an embodiment of the present disclosure;

FIG. 3 is a block diagram illustrating the configuration of an apparatus for acquiring data synchronization in a passive optical network according to an embodiment of the present disclosure;

FIG. 4 is a diagram illustrating the effect of skew on the order of data according to an embodiment of the present disclosure;

FIG. 5 is a block diagram providing a detailed illustration of an example where the apparatus for acquiring data synchronization in a passive optical network, illustrated in FIG. 3, operates at 128-bit, 50G speed;

FIG. 6 is an operation flowchart illustrating a method for acquiring data synchronization in a passive optical network according to an embodiment of the present disclosure; and

FIG. 7 is a diagram illustrating a computer system according to an embodiment of the present disclosure.

### DESCRIPTION OF THE PREFERRED EMBODIMENTS

The present disclosure will be described in detail below with reference to the accompanying drawings. Repeated descriptions and those of known functions and configurations that are deemed to unnecessarily obscure the gist of the present disclosure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated to make the description clearer.

In the present specification, it should be understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof may also be present or added.

Hereinafter, embodiments of the present disclosure will be described in detail with reference to the attached drawings.

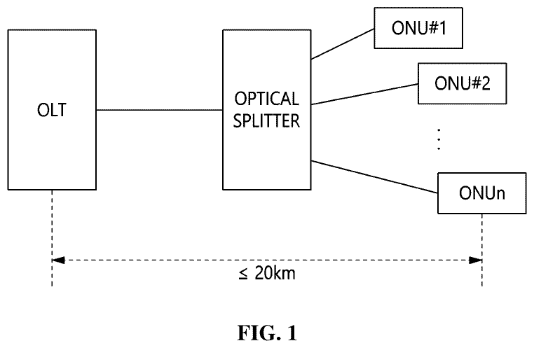

FIG. 1 is a block diagram illustrating a passive optical network according to an embodiment of the present disclosure.

Referring to FIG. 1, the Passive Optical Network (PON) is a subscriber section network from a central office (telephone office), which is configured in a 1:N structure in which one or more Optical Network Units (ONU) are connected to one Optical Line Terminal (OLT). The maximum distance between OLT and each ONU is limited to 20 km, and can accommodate up to 128 ONUs depending on a power budget.

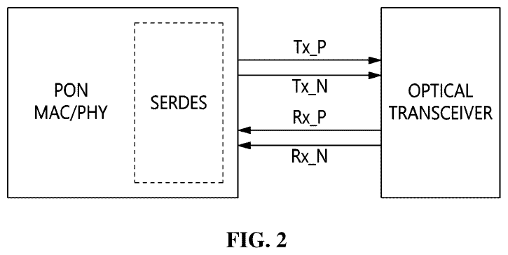

FIG. 2 is a block diagram illustrating a data interface between a PON MAC/PHY chip and an optical transceiver according to an embodiment of the present disclosure.

Referring to FIG. 2, a hardware board in each of the OLT and ONUs illustrated in FIG. 1 may include a PON media access controller/physical interface transceiver (MAC/PHY) chip which processes PON packets and user/system Ethernet frames, and an optical transceiver which is used for signal conversion between electrical signals and optical signals, as illustrated in FIG. 2.

Here, the PON MAC/PHY chip may correspond to an apparatus for acquiring data synchronization in a passive optical network according to an embodiment of the present disclosure. In the PON MAC/PHY chip, packets are processed in parallel for high-speed processing. When a system clock is 100 MHz, and a data bus is a 64-bit bus, the PON MAC/PHY chip may have capability of theoretically processing data at a speed of 6.4 Gb/s.

Data may be transmitted (Tx_P/N) and received (Rx_P/N) between the PON MAC/PHY chip and the optical transceiver through a serial differential signal for each channel, as illustrated in FIG. 2.

Therefore, the PON MAC/PHY chip connected to the optical transceiver may include a serializer and deserializer (SerDes or SERDES) device which converts parallel signals into serial signals during output and converts serial signals into parallel signals during input. For example, the SerDes speed of a Gigabyte Passive Optical Network (GPON) is 2488.32 Mb/s, and the SerDes speed of a 10-Gigabit XG-PON is 9953.28 Mb/s (hereinafter referred to as 10 Gb/s).

Here, in order to implement 50G-PON in a FPGA, two SerDes devices need to be used. Even when the 50G-PON is implemented in ASIC, the use of two 25 Gb/s SerDes devices can offer better cost efficiency than the use of one 50 Gb/s SerDes device.

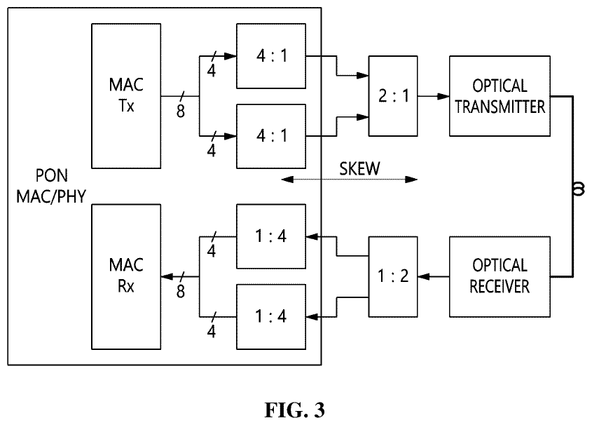

FIG. 3 is a block diagram illustrating the configuration of an apparatus for acquiring data synchronization in a passive optical network according to an embodiment of the present disclosure.

Referring to FIG. 3, the apparatus for acquiring data synchronization in a passive optical network according to the embodiment of the present disclosure may be an example of the case where 8-bit parallel data is used and two SerDes devices are used.

The apparatus for acquiring data synchronization in the passive optical network according to the embodiment of the present disclosure may include a PON MAC/PHY transmission unit, a PON MAC/PHY reception unit, two 4:1 serializers, and two 1:4 deserializers.

It can be seen that the PON MAC/PHY transmission unit uses two 4:1 serializers, and the PON MAC/PHY reception unit uses two 1:4 deserializers.

Dedicated chips that perform a function of multiplexing and demultiplexing two streams of serial data may be provided outside the PON MAC/PHY chip, and may be connected to an optical transmitter and an optical receiver, respectively.

The PON MAC/PHY transmission unit may transmit 8-bit parallel data of a MAC transmission (MAC Tx) packet as two streams of serial data through the two 4:1 serializers.

The PON MAC/PHY reception unit may receive 8-bit parallel data by combining two streams of 4-bit data streams converted by the two 1:4 deserializers.

Skew may occur between the 4:1 serializers of the transmission unit and a 2:1 multiplexer outside the chip due to the differences in lane lengths on the board and the variations in processing times of individual devices. For the same reason, skew may also occur between a 1:2 demultiplexer and the 1:4 deserializers.

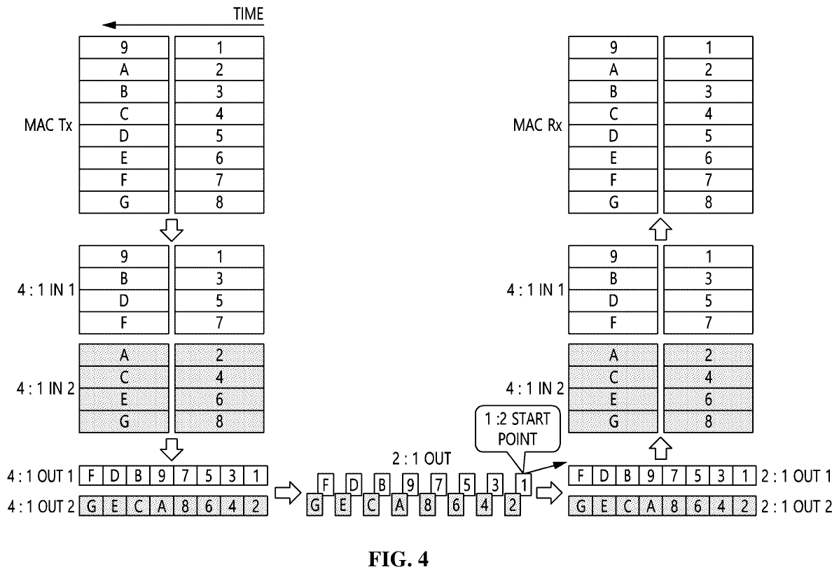

FIG. 4 is a diagram illustrating the effect of skew on data order according to an embodiment of the present disclosure.

Referring to FIG. 4, it is assumed that, for MAC Tx data in 8-bit units, 16-bit information of 1, 2, 3, . . . , f, g is generated in time order. The generated information may be input to respective 4:1 serializers after being separated into odd numbers and even numbers corresponding to bit positions. When there is no skew, the output of 4:1 serializer 1 (4:1 out1) and the output of 4:1 serializer 2 (4:1 out2) may appear, without change, as the output of the 2:1 multiplexer (2:1 out) in the bit order of 1, 2, 3, . . . , f, and g.

In the reception unit, transmission data is received through a reverse process that restores the correct data order, allowing data restoration. When the output of 4:1 serializer 2 is delayed by one bit from the output of 4:1 serializer 1, 4:1 out2 appears to be delayed by one bit from 4:1 out1. In this case, since the output order of the data output from the 2:1 multiplexer is 1, 3, 2, 5, 4, . . . , the input order of streams of data that are input to MAC Rx cannot be maintained.

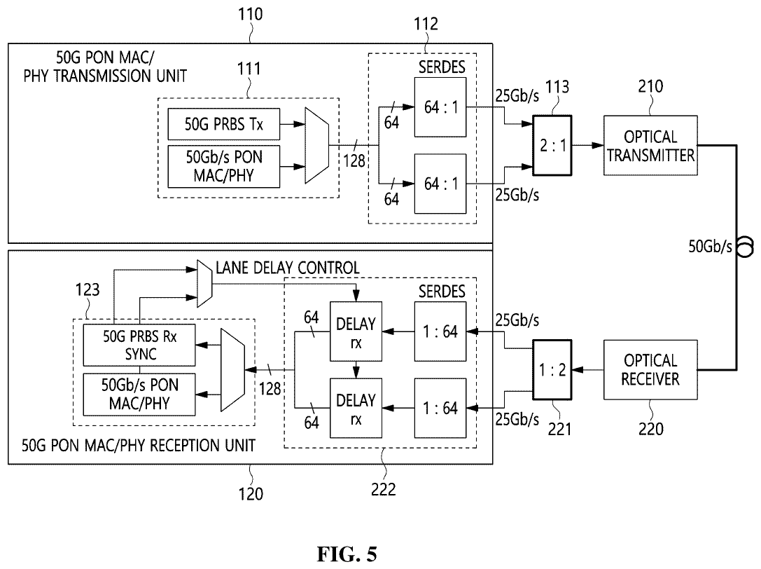

FIG. 5 is a block diagram illustrating in detail an example in which the apparatus for acquiring data synchronization in a passive optical network, illustrated in FIG. 3, operates at a 128-bit, 50G speed.

Referring to FIG. 5, the apparatus for acquiring data synchronization in the passive optical network may include a transmission unit 110 and a reception unit 120.

In the transmission unit 110, a 50G PRBS Tx and 50 Gb/s PON MAC/PHY transmitter 111 may selectively transmit a Pseudo Random Bit Stream (PRBS) pattern for a test purpose and a PON MAC/PHY frame.

Here, the transmission unit 110 may output two streams of 25 Gb/s serial data through two transmission-side SerDes devices 112.

Here, the transmission unit 110 may transmit a 50 Gb/s optical signal through an external 2:1 multiplexer 113 and an optical transmitter 210.

The SerDes configuration may be changed depending on the transmission speed (25 Gb/s, or 50 Gb/s or higher) of PON and the size of a data bus.

The reception unit 120 may receive at least two streams of serial data using at least two deserializers.

Here, in the reception unit 120, two reception-side SerDes devices 222 may receive two 25 Gb/s electrical signals, respectively, after the optical signal is split into two 25 Gb/s electrical signals through an optical receiver 220 and a 1:2 demultiplexer 221.

In the reception unit 120, a 50G PRBS Rx SYNC and 50 Gb/s PON MAC/PHY receiver 123 may be selectively operated depending on the test mode.

The 50G PRBS Rx SYNC and 50 Gb/s PON MAC/PHY receiver 123 of the reception unit 120 may acquire frame synchronization from initially input 128-bit data.

The 50G PRBS Rx SYNC and 50 Gb/s PON MAC/PHY receiver 123 may acquire frame synchronization by comparing a fixed pattern, such as the delimiter of a frame header having a preset fixed length, with the input data using a bit shift method, where the input data is delayed by one bit and a matching bit position is searched for.

Also, the 50G PRBS Rx SYNC may identify the starting portion of a PRBS cycle from 128-bit data even for a PRBS pattern.

Here, the 50G PRBS Rx SYNC may delay the input data by one bit until the pattern of the first cycle of PRBS matches the input data.

Generally, when one SerDes device is used, the order of bits in a frame does not change, and thus synchronization may be acquired using only the bit shift method.

However, when two SerDes devices are used in each of the transmission unit 110 and the reception unit 120, the bit order may shift due to skew between lanes, making it difficult to acquire frame synchronization or detect the PRBS cycle using only the bit shift method.

Therefore, in the present disclosure, the reception-side SerDes devices 222 may use Delay Rx units to compensate for lane-specific skew.

Here, the reception unit 120 may perform lane delay control on at least two streams of serial data based on a preset lane number and bit delay count (i.e., bit delay count) by using the Delay Rx units.

Here, the reception unit 120 may delay the at least two streams of serial data that are input to the at least two deserializers by the preset number of bit delays for respective preset lane numbers.

Each Delay Rx unit may delay serial data that is input from the corresponding SerDes device by one bit.

Here, the Delay Rx units may be operated independently for each lane.

Here, each Delay Rx unit may compensate for skew between lanes by incrementally increasing the delay by one bit per lane.

When synchronization acquisition fails using a bit shift method during a PRBS cycle or a 50 Gb/s PON MAC/PHY frame period, the reception unit 120 may attempt to acquire synchronization by incrementally increasing the delay of the first Delay Rx unit's output data by one bit through lane delay control.

Here, the reception unit 120 may perform synchronization acquisition on parallel data while increasing the preset number of bit delays for any one of two deserializers by one bit.

Here, the reception unit 120 may perform synchronization acquisition on parallel data while increasing the preset number of bit delays for the other of two deserializers by one bit.

The reception unit 120 may reset the delay time of the output data of the first Delay Rx unit to an initial state when the delay of the first Delay Rx unit reaches the maximum delay value.

Also, the reception unit 120 may incrementally delay the output data of the second Delay Rx unit by one bit whenever synchronization acquisition fails in the same manner as the first Delay Rx unit.

Here, when the delay of the second Delay Rx unit reaches the maximum delay value, the reception unit 120 may reset the output timing to its initial state, and may restart the process from the initial step.

In this case, when the preset number of bit delays for the other of the two deserializers reaches the maximum delay value, the reception unit 120 may reset the output time of the parallel data to the initial state, and may change the current lane to the next lane.

Here, the reception unit 120 may compensate for skew between the lanes using the delay time at which data synchronization is acquired in the parallel data while the number of bit delays for each lane is changed.

The maximum Rx delay value is determined based on the maximum delay time that can exist between two lanes.

Because bit errors may occur in a channel environment, bit error tolerance needs to be considered during fixed-length pattern matching.

In this way, when the delay time of the Delay Rx unit for each lane is changed, the delay time at the time of acquiring synchronization may be a skew compensation value between lanes.

As described above, since the present disclosure may compensate for skew even if it is implemented using two or more SerDes devices, data reception and synchronization acquisition at 50 Gb/s may be performed.

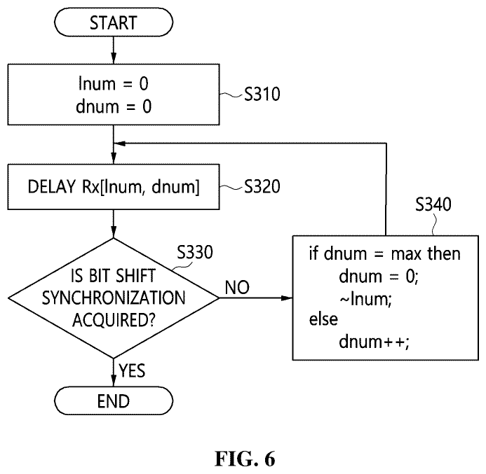

FIG. 6 is an operation flowchart illustrating a method for acquiring data synchronization in a passive optical network according to an embodiment of the present disclosure; and

Referring to FIG. 6, the method for acquiring data synchronization in the passive optical network according to the embodiment of the present disclosure may set a lane number and the number of bit delays at step S310.

That is, at step S310, a lane number (lnum) and the number of bit delays (dnum) may be set as lnum=0 and dnum=0.

‘lnum’ refers to the lane number, which is valid in the range of 0 to (number of lanes−1). That is, when two lanes are used, the lane number (lnum) can be either 0 or 1.

‘dnum’ refers to the number of bit delays applied to the corresponding lane.

That is, when dnum is 3, output may appear after being delayed by a time corresponding to 3 bits from input.

In addition, the method for acquiring data synchronization in the passive optical network according to the embodiment of the present disclosure may perform lane delay control at step S320.

That is, at step S320, Delay Rx[lnum, dnum] may be performed.

Here, at step S320, at least two streams of serial data may be received using at least two deserializers.

Here, at step 320, the two reception-side SerDes devices 222 may receive each receive a 25 Gb/s electrical signal, after separating the optical signal into the two 25 Gb/s electrical signals through the optical receiver 220 and the 1:2 demultiplexer 221.

In this case, at step S320, the data of the lane corresponding to lnum may be output after being delayed by a bit corresponding to dnum through Delay Rx[lnum, dnum].

Further, the method for acquiring data synchronization in the passive optical network according to the embodiment of the present disclosure includes acquiring bit shift synchronization at step S330.

That is, at step S330, bit shift synchronization may be acquired in data.

Here, at step S330, the 50G PRBS Rx SYNC and 50 Gb/s PON MAC/PHY receiver 123 may be selectively operated based on the test mode.

Here, at step S330, the 50 Gb/s PON MAC/PHY reception unit 123 of the reception unit 120 may acquire frame synchronization from initially input 128-bit data.

Here, at step S330, the 50G PRBS Rx SYNC and 50 Gb/s PON MAC/PHY receiver 123 may acquire frame synchronization by comparing a fixed pattern, such as the delimiter of a frame header having a preset fixed length, with the input data using a bit shift method, where the input data is delayed by one bit and a matching bit position is identified.

Here, at step S330, the 50G PRBS Rx SYNC may identify the starting portion of a PRBS cycle from 128-bit data even for a PRBS pattern.

Here, at step S330, the 50G PRBS Rx SYNC may delay the input data by one bit until the pattern of the first cycle of PRBS matches the input data.

Here, at step S330, lane delay control may be performed on at least two streams of serial data based on a preset lane number and the preset number of bit delays by using the Delay Rx units.

Here, at step S330, the at least two streams of serial data that are input to the at least two deserializers may be delayed by the preset number of bit delays for respective preset lane numbers.

Here, at step S330, each Delay Rx unit may delay serial data that is input from the corresponding SerDes device by one bit.

Here, at step S330, each Delay Rx unit may compensate for skew between lanes by incrementally increasing the delay by one bit per lane.

Furthermore, the method for acquiring data synchronization in the passive optical network according to the embodiment of the present disclosure may repeatedly perform synchronization acquisition at step S340.

That is, at step S340, when the acquisition of bit shift synchronization fails, synchronization acquisition may be repeatedly performed by increasing dnum by 1. When dnum reaches the preset maximum value, dnum is reset to 0, and the lane may be changed to the next lane.

Here, at step S340, when synchronization acquisition fails using a bit shift method during a PRBS cycle or any 50 Gb/s PON MAC/PHY frame period, synchronization acquisition is attempted by incrementally increasing the delay time of the output data of the first Delay Rx unit by one bit through lane delay control.

Here, at step S340, synchronization acquisition may be performed on parallel data while increasing the preset number of bit delays for either of the two deserializers by one bit.

Here, at step S340, synchronization acquisition may be performed on parallel data while increasing the preset number of bit delays for the other of two deserializers by one bit.

Here, at step S340, the delay time of the output data of the first Delay Rx unit may be reset to its initial state when the delay of the first Delay Rx unit reaches the maximum delay value.

Also, at step S340, the delay time of the output data of the second Delay Rx unit may be increased by one bit whenever synchronization acquisition fails using the same method as the first Delay Rx unit.

Here, at step S340, when the delay of the second Delay Rx unit reaches the maximum delay value, the output time may be reset to the initial state, and the process is repeated from the initial step.

In this case, at step S340, when the preset number of bit delays for the other of the two deserializers reaches the maximum delay value, the output time of the parallel data may be reset to the initial state, and the current lane may be changed to the next lane.

Here, the reception unit 120 may compensate for skew between the lanes using the delay time at which data synchronization is acquired in the parallel data while the number of bit delays for each lane is changed.

The maximum Rx delay value is determined based on the maximum delay time that can exist between two lanes.

Because bit errors may occur in a channel environment, bit error tolerance needs to be considered during fixed-length pattern matching.

In this way, when the delay time of the Delay Rx unit for each lane is changed, the delay time during synchronization acquisition may be a skew compensation value between lanes.

As described above, since the present disclosure may compensate for skew even if it is implemented using two or more SerDes devices, data reception and synchronization acquisition can be achieved at 50 Gb/s.

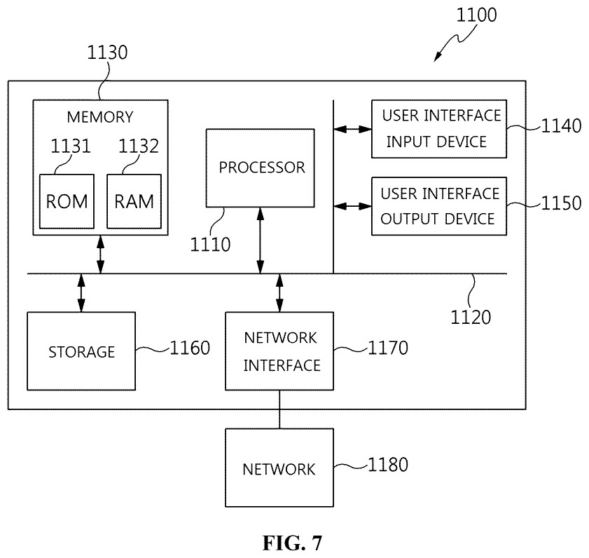

FIG. 7 is a diagram illustrating a computer system according to an embodiment of the present disclosure.

Referring to FIG. 7, an apparatus for acquiring data synchronization in a passive optical network according to an embodiment of the present disclosure may be implemented in a computer system 1100 such as a computer-readable storage medium. As illustrated in FIG. 7, the computer system 1100 may include one or more processors 1110, memory 1130, a user interface input device 1140, a user interface output device 1150, and storage 1160, which communicate with each other through a bus 1120. The computer system 1100 may further include a network interface 1170 connected to a network 1180. Each processor 1110 may be a Central Processing Unit (CPU) or a semiconductor device for executing processing instructions stored in the memory 1130 or the storage 1160. Each of the memory 1130 and the storage 1160 may be any of various types of volatile or nonvolatile storage media. For example, the memory 1130 may include Read-Only Memory (ROM) 1131 or Random Access Memory (RAM) 1132.

An apparatus for acquiring data synchronization according to an embodiment of the present disclosure may include one or more processors 1110, and memory 1130 configured to store at least one program that is executed by the one or more processors. The at least one program may be configured to receive at least two streams of serial data using at least two deserializers, perform lane delay control on the at least two streams of serial data based on a preset lane number and the preset number of bit delays, and acquire data synchronization from parallel data obtained by combining the at least two streams of serial data through the lane delay control.

Here, the at least one program may be configured to delay the at least two streams of serial data that are input to the at least two deserializers by a preset number of bit delays for each preset lane number.

Here, the at least one program may be configured to perform synchronization acquisition in the parallel data while increasing the preset number of bit delays for any one of the at least two deserializers by one bit.

Here, the at least one program may be configured to perform synchronization acquisition in the parallel data while increasing the preset number of bit delays for a remaining one of the at least two deserializers by one bit.

Here, the at least one program may be configured to, when the preset number of bit delays for the remaining one of the at least two deserializers reaches a maximum delay value, reset an output time of the parallel data to an initial state and change a current lane to a next lane.

Here, the at least one program may be configured to compensate for skew between lanes using a delay time when data synchronization is acquired in the parallel data while changing the number of bit delays for each lane.

The present disclosure can provide a high-speed interface structure and high-speed synchronization acquisition of PON media access controller (MAC)/physical interface transceiver (PHY).

Further, the present disclosure can improve cost efficiency without using an expensive Serializer/Deserializer (SerDes).

As described above, in the apparatus and method for acquiring data synchronization in a passive optical network according to embodiments of the present disclosure, the configurations and schemes in the above-described embodiments are not limitedly applied, and some or all of the above embodiments can be selectively combined and configured such that various modifications are possible.

What is claimed is:

1. An apparatus for acquiring data synchronization in a passive optical network, comprising:
one or more processors; and
a memory configured to store at least one program that is executed by the one or more processors,
wherein the at least one program is configured to:
receive at least two streams of serial data using at least two deserializers,
perform lane delay control on the at least two streams of serial data based on a preset lane number and a preset number of bit delays, and
acquire data synchronization from parallel data obtained by combining the at least two streams of serial data through the lane delay control.

2. The apparatus of claim 1, wherein the at least one program is configured to delay the at least two streams of serial data that are input to the at least two deserializers by a preset number of bit delays for each preset lane number.

3. The apparatus of claim 2, wherein the at least one program is configured to perform synchronization acquisition in the parallel data while increasing the preset number of bit delays for any one of the at least two deserializers by one bit.

4. The apparatus of claim 3, wherein the at least one program is configured to perform synchronization acquisition in the parallel data while increasing the preset number of bit delays for a remaining one of the at least two deserializers by one bit.

5. The apparatus of claim 4, wherein the at least one program is configured to, when the preset number of bit delays for the remaining one of the at least two deserializers reaches a maximum delay value, reset an output time of the parallel data to an initial state and change a current lane to a next lane.

6. The apparatus of claim 4, wherein the at least one program is configured to compensate for skew between lanes using a delay time when data synchronization is acquired in the parallel data while changing the number of bit delays for each lane.

7. A method for acquiring data synchronization in a passive optical network, the method being performed by an apparatus for acquiring data synchronization in the passive optical network, the method comprising:
receiving at least two streams of serial data using at least two deserializers;
performing lane delay control on the at least two streams of serial data based on a preset lane number and a preset number of bit delays; and
acquiring data synchronization from parallel data obtained by combining the at least two streams of serial data through the lane delay control.

8. The method of claim 7, wherein performing the lane delay control comprises:
delaying the at least two streams of serial data that are input to the at least two deserializers by a preset number of bit delays for each preset lane number.

9. The method of claim 8, wherein acquiring the data synchronization comprises:
performing synchronization acquisition in the parallel data while increasing the preset number of bit delays for any one of the at least two deserializers by one bit.

10. The method of claim 9, wherein acquiring the data synchronization further comprises:
performing synchronization acquisition in the parallel data while increasing the preset number of bit delays for a remaining one of the at least two deserializers by one bit.

11. The method of claim 10, wherein acquiring the data synchronization further comprises:
when the preset number of bit delays for the remaining one of the at least two deserializers reaches a maximum delay value, resetting an output time of the parallel data to an initial state and changing a current lane to a next lane.

12. The method of claim 10, wherein acquiring the data synchronization further comprises:
compensating for skew between lanes using a delay time when data synchronization is acquired in the parallel data while changing the number of bit delays for each lane.
